(19) United States
(12) Patent Application Publication
(10) Pub. No.: US 2023/0380377 A1
(43) Pub. Date: Nov. 30, 2023

(54) LITTER BOX EXHAUST SYSTEM

(71) Applicant: Richard Chambers, Citra, FL (US)

(72) Inventor: Richard Chambers, Citra, FL (US)

(21) Appl. No.: 18/323,136

(22) Filed: May 24, 2023

Related U.S. Application Data
(60) Provisional application No. 63/346,658, filed on May 27, 2022.

(51) Int. Cl. A01K 1/01; A01K 1/00; B01D 46/00

(52) U.S. Cl. CPC A01K 1/0107; A01K 1/0052; B01D 46/0038

(57) ABSTRACT

The present disclosure provides an exhaust system for litter boxes or animal enclosures and related methods. One such system comprises a litter box enclosure having an opening in a cover of the litter box enclosure; a duct conduit that is configured to mate a first end of the duct conduit to the opening of the litter box enclosure; an exhaust fan mechanism having an intake port and an output port, wherein the intake port is configured to mate with a second end of the duct conduit; an additional duct conduit having two ends, wherein a first of the two ends is configured to mate with the output port of the exhaust fan mechanism; and an air filter having an intake opening that is configured to mate with a second of the two ends of the additional duct conduit. Other systems and methods are also provided.

### CROSS-REFERENCE TO RELATED APPLICATION

This application claims priority to co-pending U.S. provisional application entitled, “Litter Box Exhaust System,” having Ser. No. 63/346,658, filed May 27, 2022, which is entirely incorporated herein by reference.

### TECHNICAL FIELD

The present disclosure is generally related to an exhaust system for litter boxes or animal enclosures.

### BACKGROUND

A typical cat litter box requires frequent changes to or cleaning of the cat litter in an attempt to avoid unpleasant smells or odors emanating from the litter box. Further, cat litter boxes are often located in spare rooms, closets, laundry rooms, or other poorly ventilated spaces to keep them hidden from view which does not necessarily provide access to air flow and natural ventilation inside the home that can help in dissipating the odors related to the litter box. Nonetheless, even if the litter box is located in an open space, the available ventilation may not be effective in removing odors from the litter box to a home owner's satisfaction.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-2 show an exemplary litter box exhaust system that aids in removing odors emanating from a litter box (or other animal enclosure) in accordance with various embodiments of the present disclosure.

FIGS. 3-5 show photographs of a prototype for an exemplary litter box exhaust system in accordance with embodiments of the present disclosure.

FIG. 6 shows a flowchart of an exemplary method for implementing a litter box exhaust system in accordance with embodiments of the present disclosure.

### DETAILED DESCRIPTION

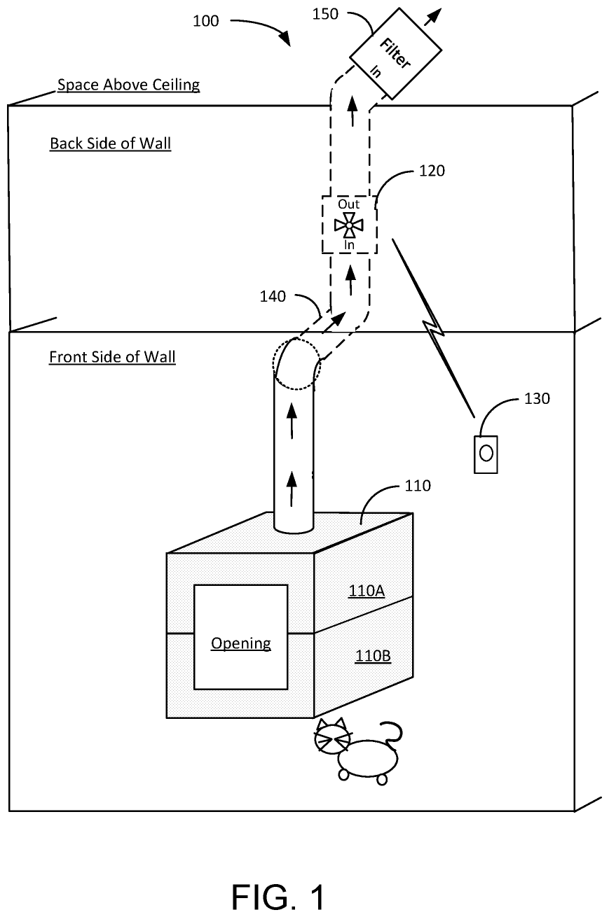

In various embodiments, the present disclosure provides an exhaust system for litter boxes or animal enclosures and related methods. Referring now to FIG. 1, an exemplary litter box exhaust system 100 aids in removing odors emanating from a litter box 110 (and may be adapted for use with an animal enclosure). Accordingly, while the present disclosure refers to a cat litter box enclosure in the disclosed embodiments, other animal enclosures may also be utilized in connection with an exhaust system of the present disclosure to aid in the removal or elimination of odors associated with animal enclosures, such as, but not limited to, aquariums, terrariums, bird cages, dog houses, small animal enclosures/cages, etc.

Referring back to FIG. 1, an exemplary litter box exhaust system 100 provides an exhaust fan mechanism 120 for directing or drawing odors away from the litter box 110 to a ventilation space within the home or outside of the home. In various embodiments, the exhaust fan mechanism 120 includes a fan and motor assembly that is located remotely from the litter box itself (and can be plugged into a power outlet or hardwired into the household wiring or powered by other means). In this way, any vibrations or sounds that the fan and/or motor may produce will not occur at the liter box 110 and thus will not disturb the pet/animal that is utilizing the litter box or in areas near the litter box. Further, in accordance with the present disclosure, the fan mechanism 120 itself may be designed to run at low speeds that are sufficient to remove odors from the litter box but not be at a speed that causes undue vibrations or sounds attributed to the exhaust fan mechanism. Accordingly, in certain embodiments, the exhaust fan mechanism can be controlled via a handset or wall mounted controller device 130 having different speed settings. In various embodiments, a user's smart phone may be programmed to interact with and communicate (over a communication link) with the exhaust fan mechanism (e.g., over WiFi or Bluetooth communications) and act as the controller device to the exhaust fan mechanism 120. Additional settings may also be programmed by the user such as a schedule of operations or a timer for the exhaust fan mechanism or other parameters that trigger operation of the exhaust fan mechanism 120 and/or turn of the exhaust fan mechanism in situations where the user may not desire for the fan to run in constant operation. In certain embodiments, the litter box 110 may be equipped with sensors that communicate with the controller device and provide the parameters that trigger or adjust operation of the exhaust fan, such as parameters related to movement of cat into or out of the litter box, a threshold amount of odor or chemicals detected in the litter box, etc.

In various embodiments, the exhaust fan assembly or mechanism 120 is coupled to the litter box via a duct conduit 140, such as a hose or tubing (e.g., a 4 inch diameter cylindrical hose). However, the duct conduit can be of varying sizes and shapes and is not limited to the examples shown in the figures. Accordingly, in various embodiments, the duct conduit 140 may include a flexible hose that allows routing of the hose through or around obstacles that may be in the path between the litter box and the space that an air filter 150 is positioned, such as in an attic space or behind an interior wall. In such arrangements, a section of duct conduit 140 is coupled between an opening or vent of the litter box enclosure 110 and an input or intake port of the exhaust fan mechanism 120 (which is marked as “In” in FIG. 1). And, an additional section of the duct conduit 140 is coupled between an output or exhaust port of the exhaust fan mechanism 120 (which is marked as “Out” in FIG. 1) and an intake or input opening/port of the air filter component 150 (which is marked as “In” in FIG. 1). Otherwise, in certain embodiments, the duct conduit 140 may be coupled to an outside building vent that directs odors to the outside of a home, apartment, etc. (e.g., via an outside vent connection). Alternatively, or in addition to, the duct conduit 140 may include a rigid metal conduit that is routed behind a drywall. As such, a flexible portion of the duct conduit 140 (on one side of a wall of a home) may be coupled to a rigid portion of the duct conduit 140 (on an inner portion of a wall section of a home), in certain embodiments.

In various embodiments, the air filter 150 is designed to eliminate volatile organic compounds or chemicals emanating from the litter box. In certain embodiments, the air filter may utilize charcoal or other type of carbon filter and/or other materials to absorb volatile or unpleasant odorous chemicals before allowing air flow to pass through the air filter (as filtered air flow).

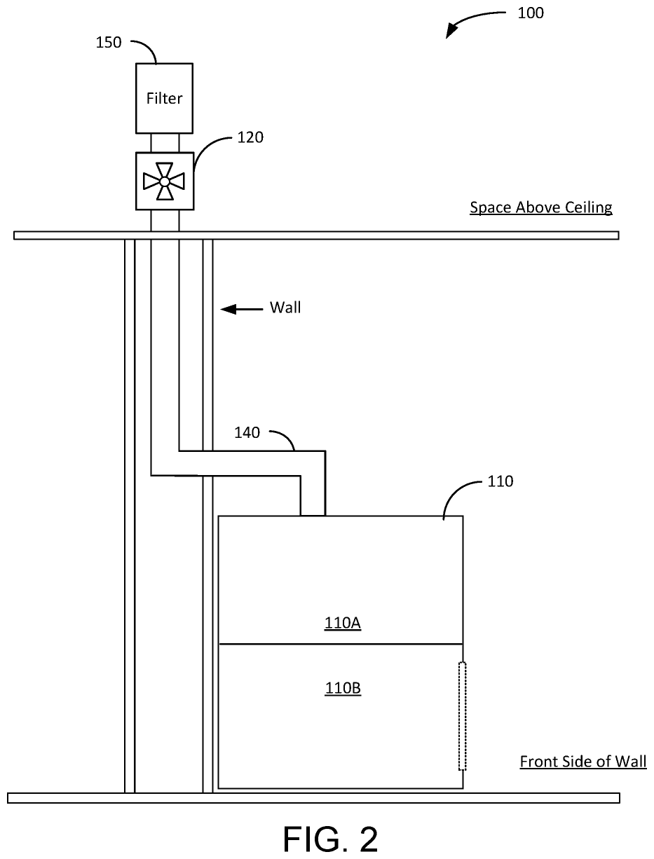

The design of exemplary litter box exhaust system 100 allows for the system to be installed and integrated in new homes or retrofitted and installed in preexisting homes, such as those having a traditional wood frame structure. For example, in certain implementations, the hose/tubing may connect to a vent pipe behind a wall of a new home that has been installed for use with the litter box exhaust system, as represented in FIGS. 1 and 2, that show the conduit that has been routed through a front side of a wall, a back side of a wall, and a space above a ceiling in one possible implementation of a litter box exhaust system 100. Thus, in certain implementations, the duct conduit 140 can be hidden from view by being routed through walls, flooring, ceilings, etc. to a desired exhaust point within a home, apartment, etc. Alternatively or in addition to, the duct conduit 140 can be routed behind or around objects within a particular home. In certain implementations, the duct conduit 140 can be hidden from view by a cover, such as finished aluminum cover that may be painted and be adapted to fit over the conduit and match the aesthetic of the room in which it resides and/or may be customized to a user's liking. In the example implementation shown in FIG. 1, the fan mechanism 120 is positioned behind the wall, and in the example implementation shown in FIG. 2, the fan mechanism is positioned in a space above a ceiling. Thus, the litter box exhaust system 100 is adaptable to many different use cases or arrangements.

Referring back to the example of FIG. 1, the duct conduit 140 is connected to an opening in a lid or cover 110A of a litter box enclosure that engages with a base portion 110B of the litter box enclosure 110. In alternative embodiments, however, an opening is not limited to only being provided in a lid or a top of an animal enclosure, and may be located in other areas, such as a side of the animal enclosure. In various embodiments, the opening may include a contoured connector that engages with or mates with a connector on an end of the conduit 140. In various embodiments, the opening may include a screen or mesh material across the opening that allows for unpleasant airborne odors to pass through the screen/mesh into an interior of the conduit as the odors are drawn by the exhaust fan mechanism away 120 from the litter box 110.

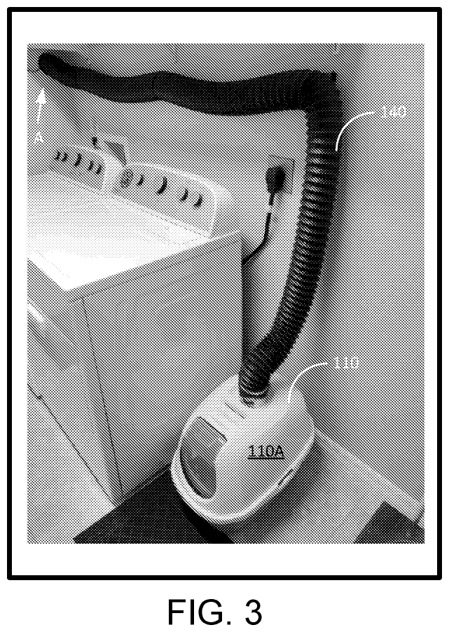

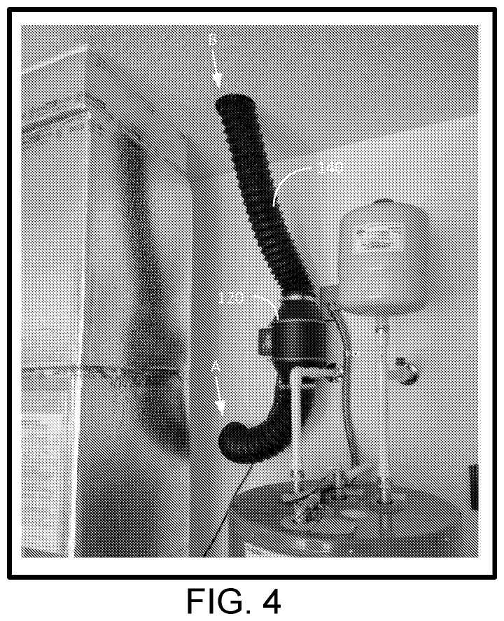

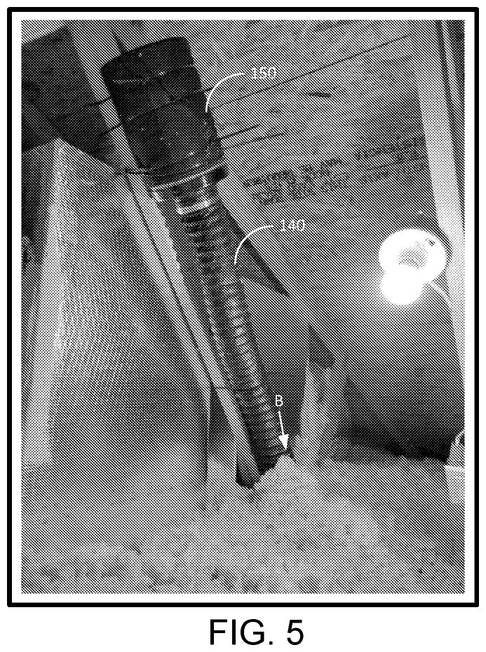

FIGS. 3-5 provide photographs of a prototype of an embodiment of the litter box exhaust system that illustrate another possible arrangement for routing the conduit 140 within a home. Accordingly, in the photograph of FIG. 3, a cat litter box 110 is shown having a conduit 140 coupled to a vent at a top of the lid or cover for the cat litter box enclosure. In this example, the conduit 140 is routed through a hole in a wall that is marked as “A.” Referring next to FIG. 4, a photograph is shown with the conduit that passed through the hole (marked as “A”) in FIG. 3 being routed through the hole into another room of the home. In this room, the fan mechanism 120 is located (away from the litter box 110) such that odors from the litter box can be drawn to the exhaust fan mechanism 120 and further drawn or directed above the fan mechanism 120 (via the conduit 140) through a hole in the ceiling (marked as “B”). Next, in FIG. 5, on the other side of the ceiling, the conduit 140 is routed to the air filter 150 in a space above the ceiling (away from the litter box 110) through the hole in the ceiling (that covered with insulation but is indicated with an arrow marked as “B”).

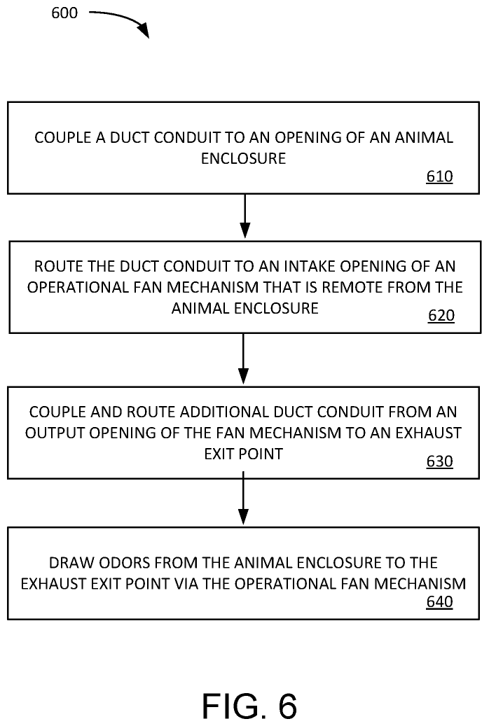

In certain embodiments, the present disclosure provides for methods for implementing an exhaust system for a litter box or animal enclosure. Referring now to FIG. 6, in one exemplary method, the method (600) comprises the act of coupling (610) a duct conduit to an opening of an animal enclosure 110 that is located inside a home or apartment (or other type of building), such as, but not limited to, an cat litter box, an aquarium, a bird cage, a small animal cage, a terrarium, dog house, etc. Next, the duct conduit is routed (620) to an intake opening or port of an operational fan mechanism 120 that is located remotely from the animal enclosure, such as, but not limited to, another room of the building. Then, at an output opening or port of the fan mechanism 120, additional duct conduit is coupled and is routed (630) to an exhaust exit point by the fan mechanism 120 that draws (640) odors from the animal enclosure 110 to the exhaust exit point, where the exhaust point may comprise an air filter 150 that removes or eliminates odors emanating from the animal enclosure 110 and/or an air vent that leads to an exterior or outside of the building to which the odors may be released.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the present disclosure. All such modifications and variations are intended to be included herein within the scope of this disclosure and protected by the following claims.

1. A method of implementing a litter box exhaust system comprising:
coupling a duct conduit to an opening of a litter box enclosure that is situated in a room of a building;
routing the duct conduit to an intake opening of an operational exhaust fan mechanism that is located remotely from the litter box enclosure;
coupling additional duct conduit to an output opening of the exhaust fan mechanism;
routing the additional duct conduit to an exhaust exit point that is outside of the room of the building; and
drawing odors from the litter box enclosure to the exhaust exit point via the operational exhaust fan mechanism.

2. The method of claim 1, wherein the exhaust exit point comprises an air filter that is coupled to the additional duct conduit, the method further comprising directing odors from the litter box enclosure to pass through the air filter.

3. The method of claim 1, wherein the exhaust exit point comprises an air vent opening within the building that leads to an exterior of the building, the method further comprising directing odors from the litter box enclosure to pass through the air vent opening.

4. The method of claim 1, further comprising setting the exhaust fan mechanism to operate in accordance with a schedule set by a user.

5. The method of claim 1, further comprising setting the exhaust fan mechanism to operate continuously.

6. The method of claim 1, further comprising setting the exhaust fan mechanism to adjust its operation based on an amount of odors sensed by a sensor positioned near the litter box enclosure.

7. The method of claim 1, wherein the duct conduit includes a flexible conduit.

8. The method of claim 1, wherein the duct conduit includes a rigid metal conduit.

9. The method of claim 1, wherein the duct conduit is routed behind a wall in the room where the litter box enclosure is situated.

10. The method of claim 1, wherein the duct conduit is routed into a ceiling of the building.

11. A litter box exhaust system comprising:
a litter box enclosure having an opening in a cover of the litter box enclosure;
a duct conduit that is configured to mate a first end of the duct conduit to the opening of the litter box enclosure;
an exhaust fan mechanism having an intake port and an output port, wherein the intake port is configured to mate with a second end of the duct conduit;
an additional duct conduit having two ends, wherein a first of the two ends is configured to mate with the output port of the exhaust fan mechanism; and
an air filter having an intake opening that is configured to mate with a second of the two ends of the additional duct conduit.

12. The system of claim 11, wherein the air filter comprises a carbon filter.

13. The system of claim 11, wherein the duct conduit comprises a cylindrical conduit having a 4 inch diameter.

14. The system of claim 11, wherein the duct conduit includes a flexible conduit.

15. The system of claim 11, wherein the duct conduit includes a rigid metal conduit.

16. The system of claim 11, wherein the exhaust fan mechanism is programmable to operate at different speeds.

17. A method of implementing an animal enclosure exhaust system comprising:
coupling a duct conduit to an opening of an animal enclosure that is situated in a room of a building;
routing the duct conduit to an intake opening of an operational exhaust fan mechanism that is located remotely from the animal enclosure;
coupling additional duct conduit to an output opening of the exhaust fan mechanism;
routing the additional duct conduit to an exhaust exit point that is outside of the room of the building; and
drawing odors from the animal enclosure to the exhaust exit point via the operational fan mechanism.

18. The method of claim 17, wherein the animal enclosure comprises a small animal enclosure.

19. The method of claim 17, further comprising:
mating an air filter having an intake opening with the additional duct conduit at the exhaust exit point.

20. The method of claim 17, wherein the animal enclosure comprises an aquarium, a terrarium, a bird cage, or a dog house.
